(19) United States
(12) Patent Application Publication
(10) Pub. No.: US 2014/0278840 A1
(43) Pub. Date: Sep. 18, 2014

(54) TELEMETRY-BASED VEHICLE POLICY ENFORCEMENT

(71) Applicant: INRIX Inc., Kirkland, WA (US)

(72) Inventors: Christopher L. Scofield, Seattle, WA (US); Scott Marshall Sedlik, Mercer Island, WA (US)

(21) Appl. No.: 13/843,676

(22) Filed: Mar. 15, 2013

(51) Int. Cl. G07C 5/00

(52) U.S. Cl. CPC G07C 5/008
USPC 705/13; 701/1; 701/118; 701/119; 705/14.49

(57) ABSTRACT

Vehicles operation is often regulated by vehicle operation policies, such as operator and vehicle licensing, safe operation rules, and emissions testing, as well as advisory policies (e.g., safety tips) and infrastructure policies (e.g., traffic congestion reduction). However, enforcement of vehicle operation policies may be infrequent, costly, inaccurate, and/or ineffective for particular types of problems. Presented herein are techniques for enforcing vehicle operation policies using vehicle telemetrics detected by a vehicle telemetry sensor and reported to telemetric monitoring components during operation of the vehicles. For example, in-car emissions sensors may regularly report emissions data to roadside monitors, enabling continuous monitoring, early detection of emissions problems, and accurate measurements during road travel. Additional telemetric exchange may promote the persuasion of advisory vehicle operation policies, such as safety tips, and the transmission of travel information of interest to other vehicles and individuals, such as road hazards, traffic congestion, and available parking spots.

### BACKGROUND

Within the field of vehicle travel, many scenarios involve an operation policy recommended or applied by an agency to individuals while operating such motor vehicles. For example, a motor vehicle bureau may enforce restrictions regarding the licensing of drivers permitted to operate vehicles, the safety and emissions of vehicles during operation, and the velocity and moving regulations of motor vehicles operated in particular areas. Similar agencies may exist for other vehicular operation, such as aircraft, boats, trains, and construction equipment. Other vehicle operation policies may be implemented to control the infrastructure of the travel system; e.g., operation on a highway may be regulated by tolls that are used to maintain the condition of the highway. Still other vehicle operation policies may be advisory in nature, such as operating suggestions provided to vehicle operators to encourage safe vehicle operation.

In order to enforce such vehicle operation policies, respective agencies may utilize a variety of mechanisms. As a first example, the agencies may condition the sale of vehicles or the licensing of operators on particular conditions, such as a driving license examination. As a second example, the agencies may condition continued licensure on periodic reexamination, such as periodic emissions checks for motor vehicles. As a third example, the agencies may utilize human and automated techniques to monitor individuals operating the vehicles in various travel regions, such as traffic officers and traffic cameras. As a fourth example, automated or human-manned toll booths may be implemented at the entrances to highways to collect tolls. These and other techniques may be utilized to enforce vehicle operation policies upon the operation of vehicles by individuals.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

The enforcement of vehicle operation policies through licensing and monitoring techniques may be inefficient or ineffective for several reasons. As a first example, active monitoring, such as by traffic officers and cameras, may be sporadic and costly. As a second example, periodic checks of some types of licensing may be infrequent (e.g., emissions checks may be enforced on an annual or biannual basis), and may therefore allow problems to persist for extended periods of time between checks. As a third example, some forms of testing may evaluate operating characteristics in an artificial setting (e.g., testing vehicle emissions in a testing facility, or vision tests applied at a licensing bureau), and may inaccurately reflect the tested characteristics exhibited during regular operation of the vehicle. As a fourth example, many desirable vehicle operation policies may be difficult to enforce against particular individuals; e.g., reducing traffic in a particular travel region, such as a highway that is frequently congested, may be difficult to reduce through individual persuasion. As a fifth example, advisory vehicle operating policies, such as safety tips for vehicle operators, may be limited to educational messages, which may be poorly received, misunderstood, and/or under appreciated.

Presented herein are techniques for enforcing vehicle operation policies using telemetrics provided by vehicle telemetry sensors during vehicle operation. As a first example, vehicle sensors may be capable of detecting engine properties that are indicative of emissions, and reporting such emissions data to telemetric monitoring components, such as servers or wireless communications devices operated by a vehicle policy enforcement bureau that are positioned along various roadways. As a second example, tolls may be collected by vehicle telematics positioned within a vehicle, where such tolls are based on current operating properties of the vehicle (e.g., the current occupancy or weight of the vehicle) and automatically billed to an owner of the vehicle. As a third example, vehicle operation policies may be adjusted for the current conditions of a travel region, such as identifying a congestion or carbon emissions on a particular highway and charging tolls for entering the highway that are proportional to the congestion or emissions, thereby using a pricing mechanism to adjust individual behavior and alleviate problems. Other variations involve the transmission of data to cloud-based services that provide various types of evaluation regarding the vehicles, and the sharing of data among vehicles relating to the traffic region in which such vehicles are operating. These and other uses of vehicle telemetry transmitted from vehicles during operation may be devised and implemented in accordance with the techniques presented herein.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of an exemplary scenario featuring various vehicle operation policies and enforcement mechanisms applied at various stages of vehicle operation.

FIG. 2 is an illustration of an exemplary scenario featuring an automated application of vehicle operation policies using operating telemetrics during vehicle operation in accordance with the techniques presented herein.

FIG. 3 is a flow diagram illustrating an exemplary method of enforcing vehicle operation policies to vehicles operating in a travel region in accordance with the techniques presented herein.

FIG. 4 is a flow diagram illustrating an exemplary method of facilitating operation of a vehicle by an individual through the use of operating telemetrics during operation of the vehicle in accordance with the techniques presented herein.

FIG. 5 is a component block diagram of an exemplary system for enforcing vehicle operation policies to vehicles operating in a travel region in accordance with the techniques presented herein.

FIG. 6 is an illustration of an exemplary computer-readable medium comprising processor-executable instructions configured to embody one or more of the provisions set forth herein.

FIG. 7 is an illustration of an exemplary scenario featuring an application of tolls enforcing a vehicle operation policy based on current conditions of a travel region and the operating properties of the vehicle.

FIG. 8 is an illustration of an exemplary scenario featuring an exchange of telemetric information among vehicles during operation.

FIG. 9 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

### A. INTRODUCTION

FIG. 1 presents an illustration of an exemplary scenario featuring the regulation of the operation of vehicles by individuals 102, such as an automobile and a driver. In such scenarios, a wide variety of vehicle operation polices may be created by a government regulatory agency or organization to promote the proficiency of the individuals 102, the safety and reliability of the vehicles 104, and the maintenance of travel infrastructure, such as roadways. To this end, the government regulatory agency or organization may utilize various enforcement and monitoring techniques, such as licensing and education of the individual 102; inspection of the vehicles 104; and monitoring during operation of the vehicles 104. As a first example 100, in order to receive permission to operate the vehicle 104, the individual 102 may visit a vehicle licensing bureau 106, where a bureau official 108 may test the knowledge and capabilities of the individual 102 (such as vision and reaction time), and inspect the vehicle 104 for compliance with safety regulations, in accordance with a first vehicle operation policy 110 specifying individual and vehicle licensing standards. As a second example 112, while the individual 102 is operation of the vehicle 104 in a travel region (e.g., a particular roadway), monitoring may be performed by officers 116 and/or cameras 118, which may scan 114 or visually monitor the operation of the vehicle 104 for compliance with a second vehicle operation policy 110, such as a speed limit. Additionally, entrance to a travel region may be restricted by a toll 120 that is collected to maintain the infrastructure of the travel region. As a third example 122, re-licensing of the individual 102 and/or vehicle 104 may be conditioned on an emissions inspection to be performed at an emissions testing site 124 by another bureau official, in order to ensure the emissions 126 emitted by the vehicle 104 during simulated operation comply with a third vehicle operation policy 110 specifying emission control by devices such as catalytic converters. These and other mechanisms may be used to enforce the various vehicle operation policies 110 of the government regulatory agency or the organization.

Still further vehicle operation policies 110 may be applied not enforced against a particular individual 102 or vehicle 104, but may be created for various other ends. As a first example, a first vehicle operation policy 110 may be advisory in nature, such as a set of safety tips that individuals 102 are encouraged to follow for safe operation, but are not enforced or punished. As a second example, traffic control policies may be devised to reduce problems such as traffic congestion or excessive emissions that are frequently arising in particular areas, such as by discouraging individuals 102 from overusing particular travel regions. These and other vehicle operation policies 110 may be devised to promote travel among the individuals 102 in the travel regions.

However, in many such scenarios, the enforcement of vehicle operation policies 110 may be inefficient, ineffective, and/or inaccurate in many respects. As a first example, periodic examination of individuals 102 and/or vehicles 104 (such as driver licensing tests and vehicle inspections) maybe infrequently performed, such as annual or biannual review. However, such infrequent examination may cause problems to persist for an extended duration; e.g., a vehicle 102 that does not comply with a vehicle operation policy 110 on emissions may be operated (intentionally or unintentionally) for a year until the vehicle 104 is reinspected. As a second example, the monitoring of vehicles 104 during operation by officers 116 may be costly, and monitoring by traffic cameras 118 my involve complicated technology including speed detectors, machine vision algorithms, photography, and optical character recognition (OCR) technology to identify particular vehicles 104. As a third example, the evaluation of various vehicle operation characteristics in a controlled environment, such as testing the vision of an individual 102 in a vehicle bureau 106 or testing emissions 112 in the operating simulation of an emissions testing site 124, may be inaccurate as compared with operation of the vehicles 104 by the individuals 102 in a travel region (e.g., vision tests in a brightly lit testing facility may fail to indicate problems with an individual's night vision while driving in the evening, and emissions 126 from a vehicle 104 after a brief high-speed operation in the emission testing site 124 may not accurately reflect emissions 126 after extended, high-speed operation along a freeway.

Additional problems may arise with the enforcement of more general policies. As a first such example, advisory vehicle operation policies 110, such as safety tips, may be expressed to individuals 102 as educational advice, but such individuals 102 may not understand, appreciate, or abide by such advice, and inadequate mechanisms may be available to incentivize the individuals 102 to comply. As a second such example, some vehicle operation policies 110 may be devised for a travel region, such as the reduction of traffic congestion or excessive emissions, but may not provide rules that are enforceable against particular individuals 102. Limited mechanisms may therefore exist to achieve the vehicle operation policy 110.

### B. PRESENTED TECHNIQUES

Presented herein are techniques for enforcing vehicle operation policies 110 that involve the use of operating telemetrics detected by the vehicles 104. Modern vehicles 104 are often equipped with a wide variety of telemetry sensors that detect various performance characteristics during operation of the vehicles 104, e.g., to advise the individuals 102 operating the vehicle 104 of vehicle status, such as fuel and oil levels and engine malfunction; to assist the individual 102 in operating the vehicle 104, such as anti-lock braking systems (ABS) that detect and correct inefficient braking patterns; and to maintain accurate records of properties of the vehicle 104, such as odometers that measure mileage. However, such operating telemetrics may also be used to enforce vehicle operation policies 110. Moreover, such enforcement may be performed by transmitting such operating telemetrics to telemetric monitoring components positioned outside of the vehicle 104 in a particular travel region, such as roadside telemetrics devices that communicate with the telemetry sensors in passing vehicles 104, receive operating telemetrics of the vehicle 104, and compare such operating telemetrics with the vehicle operation policies 110 to identify a policy result. The telemetric monitoring component and/or the telemetry sensors within the vehicle 104 may apply the policy result to the individual 102 and/or the vehicle 104 (e.g., advising the individual 102 of the policy result; notifying the vehicle regulatory agency of the policy results; and/or charging the individual 102 a toll) in furtherance of the enforcement of the vehicle operation policies 110.

FIG. 2 presents an illustration of two exemplary scenarios featuring the detection of operating telemetrics 208 by telemetry sensors 204 within a vehicle 104 during operation in a travel region 202, and the transmission 206 of such operating telemetrics 208 to a telemetric monitoring component 210 positioned outside of the vehicle 104 in the travel region 202 (e.g., roadside telemetrics devices), in order to enforce various vehicle operation polices 110. In a first exemplary scenario 200, the vehicle 104 may include a telemetry sensor 204 that is configured to detect an occupancy of the vehicle 104 (e.g., the number of passengers in the vehicle 104) during operation in a particular travel region 202, and to transmit 206 the occupancy operating telemetrics 208 to a roadside telemetric monitoring component 210. The telemetric monitoring component 210 may compare the occupancy operating telemetric 208 encoded in the transmission 206 with a vehicle operation policy 110, such as a toll applied to the travel region 202 that is proportional to the occupancy of the vehicles 104. Such vehicle operation policies 110 may be selected, e.g., to charge vehicles 104 a toll that is directly proportional to vehicle occupancy (e.g., a per-individual admission fee to a region), or that is inversely proportional to vehicle occupancy (e.g., a policy promoting carpooling among individuals 102). As a result of this comparison, the telemetric monitoring component 210 may determine a policy result 212 (e.g., a toll) and may automatically apply the policy result 212 to the vehicle 104 (e.g., automatically charging the toll to an individual 102 indicated as an owner of the vehicle 104). As a second example 214, the vehicle 104 may include a telemetry sensor 204 configured to measure emissions 126 of the vehicle 104 during operation in the travel region 202, and may transmit 205 the operating telemetrics 208 encoding the detected emissions of the vehicle 104 to a roadside telemetric monitoring component 210. The telemetric monitoring component 210 may receive the transmission 206 and compare the operating telemetric 208 with a vehicle operation policy 110 involving emissions control, and may determine a policy result 212 involving an approval of the emissions measurement and a renewal of the license for the vehicle 104.

The automated transmission of vehicle operating telemetrics 208 may present various advantages for the enforcement of vehicle operation policies 110 as compared with other enforcement techniques. As a first such example, automated reporting techniques may be significant more efficient, accurate, and affordable than enforcement by officers 116. As a second such example, automated reporting techniques based on transmission 206 of operating telemetrics 208 may be significantly more accurate and less complicated than other automated techniques. For example, as compared with a traffic camera that involves speed detection, cameras, machine vision techniques to recognize vehicles 104 in the road, and optical character recognition (OCR) techniques to identify vehicle license plates, a roadside telemetric monitoring component 210 may simply involve a wireless communication component (e.g., a WiFi transceiver) that receives the operating telemetrics 208 reported by passing vehicles 104. Because the resources involved in such telemetric monitoring components 210 are comparatively simple, a greater number of such devices may be distributed throughout a travel region 202, resulting in more frequent and consistent monitoring of such operating telemetrics 208. As a second third such example, monitoring techniques involving the transmission 206 of operating telemetrics 208 may be more accurate than external detection techniques (e.g., vehicle speed or emissions that are directly detected by in-vehicle telemetry sensors 204 may be considerably more accurate than detection by cameras and speed radar), and in some cases may provide monitoring of vehicle properties 104 that are not reasonably measurable in other ways (e.g., emissions during extended operation of the vehicle 104 in ordinary operating conditions). These and other advantages may be achievable through the enforcement of vehicle operation policies 110 through the transmission 206 of operating telemetrics 208 in accordance with the techniques presented herein.

### C. EXEMPLARY EMBODIMENTS

FIG. 3 presents a first exemplary embodiment of the techniques presented herein, illustrated as an exemplary method 300 of enforcing vehicle operation policies 110 for vehicles 104 operating in a travel region 202, such as a roadway, waterway, airspace, or train rail. The exemplary method 300 may involve a device having a processor may be implemented, e.g., as a set of instructions stored in a memory component of a device (e.g., a memory circuit, a platter of a hard disk drive, a solid-state memory component, or a magnetic or optical disc) that, when executed by the processor of the device, cause the device to perform the techniques presented herein. The exemplary method 300 begins at 302 and involves executing 304 the instructions on the processor. Specifically, the instructions are configured to receive 306 from a telemetry sensor 208 of the vehicle 104 a transmission 206 encoding at least one operating telemetric 208 of the vehicle 104 while traveling in the travel region 202. The instructions are also configured to compare 308 the at least one operating telemetric 208 to the vehicle operation policy 110 to identify a policy result 212. The instructions are also configured to apply 310 the policy result 212 to the vehicle 104. Having achieved the application of the policy result 212 of the vehicle operating policy 110 in response to the operating telemetrics 208 transmitted by the vehicle 104, the exemplary method 300 achieved the techniques presented herein to enforce the vehicle operating policy 110, and so ends at 312.

FIG. 4 presents a second exemplary embodiment of the techniques presented herein, illustrated as an exemplary method 400 of facilitating an individual 102 in operating a vehicle 104 in a travel region 202. The exemplary method 400 may involve a device having a processor may be implemented, e.g., as a set of instructions stored in a memory component of a device (e.g., a memory circuit, a platter of a hard disk drive, a solid-state memory component, or a magnetic or optical disc) that, when executed by the processor of the device, cause the device to perform the techniques presented herein. The exemplary method 400 begins at 402 and involves executing 404 the instructions on the processor. Specifically, the instructions are configured to receive 406 from a telemetry sensor 204 at least one operating telemetric 208 of the vehicle 104 while traveling in the travel region 202. The instructions are also configured to transmit 408 the at least one operating telemetric 208 to a telemetric monitoring component 210 positioned outside of the vehicle 104 in the travel region 202. The instructions are also configured to, upon receiving from the telemetric monitoring component 210 at least one policy result 212 of a vehicle operation policy 110 applied to the at least one operating telemetric 208, apply 410 the at least one policy result 212 to the vehicle 104. Having facilitated the individual 102 in operating the vehicle 104 in compliance with the vehicle operation policy 110 through the use of operating telemetrics 208, the exemplary method 400 achieves the techniques presented herein, and so ends at 312.

FIG. 5 presents an illustration of an exemplary scenario 500 featuring a third exemplary embodiment of the techniques presented herein, illustrated as an exemplary system 508 for enforcing a vehicle operation policy 110 for respective vehicles 104 operating in a travel region 202. The exemplary system 508 may be implemented, e.g., on a device 502 having a processor 504 and a memory 506. Respective components of the exemplary system 508 may be implemented, e.g., as a set of instructions stored in a memory 506 of the device 502 and executable on the processor 504 of the device 502, such that the interoperation of the components causes the device 502 to operate according to the techniques presented herein. The exemplary system 508 comprises a vehicle telemetry component 510 configured to, while the vehicle 104 is currently traveling in the travel region 202, receive from at least one telemetry sensor 204 of the vehicle 104 a transmission 206 encoding at least one operating telemetric 208 of the vehicle 104. The exemplary system 508 also comprises a vehicle operation policy evaluating component 512 configured to, upon receiving the at least one operating telemetric 208 from the vehicle 104, compare the at least one operating telemetric 208 to the vehicle operation policy 110 to identify a policy result 212. The exemplary system 508 also includes a policy result applying component 514 configured to apply the policy result 212 to the vehicle 104. In this manner, the components of the exemplary system 508 may interoperate to achieve the enforcement of the vehicle operation policy 110 in the travel region 202 using the transmitted operating telemetrics 208 of the vehicle 104 in accordance with the techniques presented herein.

Still another embodiment involves a computer-readable medium comprising processor-executable instructions configured to apply the techniques presented herein. Such computer-readable media may include, e.g., computer-readable storage media involving a tangible device, such as a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a CD-R, DVD-R, or floppy disc), encoding a set of computer-readable instructions that, when executed by a processor of a device, cause the device to implement the techniques presented herein. Such computer-readable media may also include (as a class of technologies that are distinct from computer-readable storage media) various types of communications media, such as a signal that may be propagated through various physical phenomena (e.g., an electromagnetic signal, a sound wave signal, or an optical signal) and in various wired scenarios (e.g., via an Ethernet or fiber optic cable) and/or wireless scenarios (e.g., a wireless local area network (WLAN) such as WiFi, a personal area network (PAN) such as Bluetooth, or a cellular or radio network), and which encodes a set of computer-readable instructions that, when executed by a processor of a device, cause the device to implement the techniques presented herein.

An exemplary computer-readable medium that may be devised in these ways is illustrated in FIG. 6, wherein the implementation 600 comprises a computer-readable medium 602 (e.g., a CD-R, DVD-R, or a platter of a hard disk drive), on which is encoded computer-readable data 604. This computer-readable data 604 in turn comprises a set of computer instructions 606 configured to operate according to the principles set forth herein. In a first such embodiment, the processor-executable instructions 606 may be configured to, when executed by a processor 612 of a device 610, cause the device 610 to perform a method of enforcing a vehicle operation policy 110 for vehicles 104 operating in travel region 202, such as the exemplary method 300 of FIG. 3. In a second such embodiment, the processor-executable instructions 606 may be configured to, when executed by a processor 612 of a device 610, cause the device 610 to perform a method of facilitating an individual 102 in the operation of a vehicle 104 in a travel region 202, such as the exemplary method 400 of FIG. 4. In a third such embodiment, the processor-executable instructions 606 may be configured to implement a system for selecting advertisements 114 for presentation at an advertisement opportunity 116, such as the exemplary system 508 of FIG. 5. Some embodiments of this computer-readable medium may comprise a nontransitory computer-readable storage medium (e.g., a hard disk drive, an optical disc, or a flash memory device) that is configured to store processor-executable instructions configured in this manner. Many such computer-readable media may be devised by those of ordinary skill in the art that are configured to operate in accordance with the techniques presented herein.

### D. VARIABLE ASPECTS

The techniques discussed herein may be devised with variations in many aspects, and some variations may present additional advantages and/or reduce disadvantages with respect to other variations of these and other techniques. Moreover, some variations may be implemented in combination, and some combinations may feature additional advantages and/or reduced disadvantages through synergistic cooperation. The variations may be incorporated in various embodiments (e.g., the exemplary method 300 of FIG. 3; the exemplary method 400 of FIG. 4; and the exemplary system 508 of FIG. 5) to confer individual and/or synergistic advantages upon such embodiments.

D1. Scenarios

A first aspect that may vary among embodiments of these techniques relates to the scenarios wherein such techniques may be utilized. For example, the techniques presented herein may be utilized in many types of vehicles 104 operating in many types of travel regions 202, such as automobiles driven on a roadway; watercraft operated on a waterway; aircraft operated in an airspace; trains operated on a railway; trucks operated in a trucking facility, and construction equipment operated in a construction zone. The techniques may also be applied to various individuals 102 (e.g., vehicle operators, owners, and/or passengers), and in the enforcement of vehicle operating policies 110 established by various entitles, such as governments, government regulatory agencies, and public and private organizations. Many such variations may apply to scenarios in which the techniques presented herein may be effectively utilized.

D2. Operating Telemetrics Collection

A second aspect that may vary among embodiments of these techniques involves the operating telemetrics 208 and the transmission 206 to the telemetric monitoring components 206.

As a first variation of this second aspect, various types of operating telemetrics 208 may be transmitted 206 by the vehicles 104, such as vehicle occupancy; vehicle location; vehicle velocity; vehicle acceleration; vehicle braking measurements; vehicle emissions measurements; vehicle tire pressure of at least one tire of the vehicle 104; vehicle operating light settings; vehicle windshield wiper settings; vehicle climate control settings; interior or exterior vehicle temperature measurements; vehicle water measurements; vehicle ice measurements; vehicle identifiers; vehicle type descriptor; vehicle operator identifiers; and vehicle operator demographic descriptors. Additionally, the vehicles 104 may transmit 206 such operating telemetrics 208 using many transmission techniques (e.g., infrared beam, shortwave radio, cellular communication, and WiFi transmission), and in a variety of circumstances (e.g., periodically; upon detecting a nearby telemetric monitoring component 210, or receiving a request from a nearby vehicle monitoring component 210 to transmit the operating telemetric 208; or upon detecting a significant operating telemetric 208 in relation to the vehicle operating policy 110).

As a second variation of this second aspect, the telemetric monitoring components 210 may be configured to collect operating telemetrics 208 in the aggregate for a particular travel region 202. For example, from at least two vehicles 104 traveling in the travel region 202, the telemetric monitoring component 210 may receiving from the telemetry sensors 204 of respective vehicles 104 a transmission 206 encoding at least one operating telemetric 208 of the vehicle 104, and aggregating the operating telemetrics 208 of the at least two vehicles 104 into at least one aggregated operating telemetric 208 of the vehicles 104 traveling in the travel region 202. For example, the aggregated operating telemetrics 208 may indicate the average or total emissions in the travel region 202; the total number of vehicles 104 and/or individuals 102 occupying such vehicles 104; and the average speeds of the vehicles 104 through the travel region 202.

As a third variation of this second aspect, the telemetric monitoring components 210 may be configured to track historic telemetrics over time. For example, at a first time, a telemetric monitoring component 210 may receive, from the telemetry sensors 204 of respective vehicles 102, a first transmission 206 encoding at least one first operating telemetric 208 of the vehicle 104; and at a second time, may receive from the telemetry sensors 208 of the same vehicles 104 a second transmission 206 encoding at least one second operating telemetric 208 of the same vehicle 104. The telemetric monitoring component 210 may then compare the first operating telemetric 208 and the second operating telemetric 208 of respective vehicles 104 to identify a historic operating telemetric of the vehicle 104 (e.g., a change in the operating behavior of the individual 102 or the operating condition of the vehicle 104 over time). These and other variations in the collection of the operating telemetrics 208 of the vehicles 104 may be included in variations of the techniques presented herein.

D3. Vehicle Operating Policies

A third aspect that may vary among embodiments of the techniques presented herein relates to the types of vehicle operation policies 110 and the policy results 212 relating thereto.

As a first variation of this third aspect, many types of vehicle operation policies 110 may be compared against such operating telemetrics 208, such as travel safety policies; emissions policies; usage monitoring policies; toll collection policies; and census recording policies.

As a first example of this first variation, the vehicle operation policy 110 may comprise a toll applicable to the vehicles 104 in the travel region 202 As a further example, the toll may be proportional to the operating telemetric 208, such as the occupancy of the vehicles 104 (e.g., a toll that is directly proportional to vehicle occupancy as a per-individual admission fee to the travel region 202, or a toll that is inversely proportional to vehicle occupancy as a policy promoting carpooling among individuals 102). Other such tolls may relate to the emissions 126 of the vehicles 104; the speeds of the vehicles 104 in the travel region 202; and the rate of fuel consumption of the vehicles 104. In such scenarios, the telemetric monitoring component 210 may apply the policy result 212 to the vehicles 104 in accordance with the operating telemetric 208 as well as the vehicle operation policy 110.

As a second example of this first variation, the vehicle operation policy 110 may comprise a vehicle emissions monitoring policy, and the operating telemetrics 208 may comprise vehicle emissions metric detected by a vehicle emissions detector during the operation of the vehicle 104 in the travel region 202. For example, the emissions 126 of the vehicles 104 may be monitored to detect compliance with the types or volumes of the vehicle operation emissions policy. The telemetric monitoring component 210 may therefore identify the policy result 212 by comparing the vehicle emissions metrics included in the operating telemetric 208 to the vehicle emissions policy.

As a third example of this first variation, the vehicle operation policy 110 may comprise an occupancy minimum of an occupancy-restricted area of the travel region 202, such as a high occupancy vehicle (HOV) lane of a roadway. The operating telemetrics 208 may include an occupancy of the vehicle 104, and the telemetric monitoring component 210 may, upon detecting a presence of a vehicle 104 in the occupancy-restricted area, compare the occupancy of the vehicle 104 with the vehicle operation policy 110 to verify compliance with the occupancy minimum.

As a fourth example of this first variation, the vehicle operation policy 110 may be associated with a travel region usage of the travel region by the vehicles 104. For example, the vehicle operation policy 110 may be selected to reduce over utilization of a particular road by respective individuals 102, and may attempt to limit the number of uses by respective individuals 102 and/or vehicles 104 in a particular period (e.g., a vehicle count of the vehicles 104 operating in the travel region 202 in a time period; a vehicle weight of the vehicles 104 operating in the travel region 202 in a time period; a vehicle speed of the vehicles 104 operating in the travel region 202 in a time period; and a vehicle emission set of the vehicles 104 operating in the travel region 202 in a time period). Accordingly, the vehicle operation policy 110 may seek to monitor usage of the travel region 202 by the vehicles 104, and to reduce the number of vehicles 104 in the traffic region 202 in order to maintain such limits. In such scenarios, the telemetric monitoring component 210 may perform a comparison of the travel region usage indicated by the operating telemetric 208 of the vehicles 104 with the travel region usage by other vehicles 104 in the travel region 202, and apply the policy result 212 to the vehicles 104 in accordance with the comparison.

As a second variation of this third aspect, many types of policy results 212 may result from comparisons of transmitted operating telemetrics 208, including positive policy results 212 (e.g., an approval of a vehicle condition of the vehicle 104, a renewal of an operating license of the individual 102, or a compliance incentive); negative policy results 212 (e.g., a notice, warning, fine, criminal sanction presented to the individual 102 of a failed compliance regarding the vehicle operating policy 110); and neutral policy results 212 (e.g., assessing a toll to the individual 102, or simply recording the operating telemetrics 206 as census data). Additionally, the policy result 212 may be applied to the vehicle 104 by the telemetric monitoring component 210; may be transmitted to the vehicle 104 for application (e.g., notifying the individual 102); may be transmitted to a vehicle licensing bureau 106 or officer 116; and/or may be charged to the individual 102, such as automatically charging tolls to a bank account or credit card of the individual 102 registered to the vehicle 104.

FIG. 7 presents an illustration of an exemplary scenario 700 featuring an application of a vehicle operation policy 110. These and other techniques may be utilized in the comparison of the operating telemetrics 208 and the vehicle operating policy 110 and the application of the policy results 212 in accordance with the techniques presented herein. In this exemplary scenario 700, the vehicle operation policy 110 involves a reduction of vehicle emissions by vehicles 104 operating in a particular travel region 202, such as a particular roadway. The operating telemetrics 208 encoded in the transmissions 206 from the vehicles 104 may be received by the telemetric monitoring component 210 and compared with the vehicle operation policy 110, which may specify various tolls based on the current level of emissions in the travel region 202. The policy result 212 may comprise a variable toll charged by the telemetric monitoring component 210 to the individuals 102 registered to the vehicles 104. The tolls may persuade some individuals 102 not to travel in the travel region 202 during periods of high emissions 126, thereby adjusting the traffic into compliance with the vehicle operation policy 110.

As a fourth variation of this third aspect, the telemetric monitoring component 210 may transmit respective operating telemetrics 208 of various vehicles 104 (including aggregate operating telemetrics 208 and/or historic operating telemetrics 208 for a particular vehicle) to various servers or agencies. Such transmission may be performed, e.g., over the internet or a cellular network, and may be performed on a continuous, periodic, or as-requested basis. The transmissions may also be provided, e.g., to cloud services performing various forms of evaluation of the operating telemetrics 208, such as road safety, vehicle safety, and driver operating behaviors, and safety tips; to a travel regulation agency, such as a motor vehicle bureau, to update the licenses of the individuals 102 or vehicles 104, or to update the driving record of the individual 102; and/or to a fee processing service, such as a toll collector configured to collect tolls from individuals 102. Many such techniques may be used in the comparison of operating telemetrics 208 encoded in transmissions 206 from the vehicles 102 to the telemetric monitoring component 210, the comparison with the vehicle operation policy 110, and the application of the policy results 212 in accordance with the techniques presented herein.

D4. Operating Telemetry Sensors and User Interfaces

A fourth aspect that may vary among embodiments of these techniques involves the configuration of a vehicle 104 (including a device operating within the vehicle 104, such as the telemetry sensor 204, and device carried and/or worn by the individuals 102 operating the vehicles 104, such as mobile phones, tablets, laptops, global positioning system (GPS) devices, in-dash navigation and assistance devices, portable media players, portable game devices, and wearable computers such as glasses) to assist the individual 102 in the operation of the vehicle 104.

As a first variation of this fourth aspect, the vehicle 104 may participate in the transmission of operating telemetrics 206 only with the consent of the individual 102. For example, the vehicle 104 may be configured to, before transmitting the operating telemetrics 208 to the telemetric monitoring component 210, present an offer to the individual 102 to transmit the at least one operating telemetric 206 to the telemetric monitoring component 210, and receive from the individual 102 an acceptance of the offer. As a first further variation, the vehicle 104 may permit the individual 102 to customize the types of operating telemetrics 206 transmitted by the vehicles 104. As a second further variation, the vehicle 104 may incentivize the participation of the individual 102 in the transmission 206 of operating telemetrics 208 to the telemetric monitoring component 210, e.g., by conferring a benefit upon the individual 102 registered to the vehicle 104 upon transmitting the operating telemetrics 208 to the telemetric monitoring component 210 (e.g., a discount on tolls for a toll-controlled travel region 202).

As a second variation of this fourth aspect, the vehicle 104 may be configured to, upon receiving from the telemetric monitoring component 210 an operating suggestion for operating the vehicle 104, present the operating suggestion to the individual 102. For example, the telemetric monitoring component 210 may provide suggestions for reducing emissions (particularly during a high emission period in the travel region 202); for tips on conserving fuel or avoiding congested travel regions 202; and/or for safety tips that may facilitate the safe operation of the vehicle 104, such as the use of turn signals. Accordingly, upon detecting an operating change by the individual 102 conforming with the operating suggestion, confer a benefit upon the individual 102 (e.g., a discount on tolls for a toll-controlled travel region 202 upon detecting the individual's use of turn signals in response to the operating suggestion).

As a third variation of this fourth aspect, alternatively or in addition to the transmission of the operating telemetrics 208 to the telemetric monitoring component 210, the vehicle 104 may transmit the operating telemetrics 208 to a second vehicle 104 operating in the travel region 202. As a first such example, the transmission 206 may comprise transmitting the operating telemetric 208 to the telemetric monitoring component 210 through the second vehicle 104; e.g., the vehicles 104 may operate as a communications mesh to coordinate a collaborative delivery of the operating telemetrics 208 of the vehicles 104 in the travel region 202 to the telemetric monitoring components 210. As a second such example, the transmission 206 may involve sharing the operating telemetric 208 with at least one second vehicle 104 operating in the travel region 202. For example, vehicles 104 may share operating telemetrics 208 about such as the location, velocity, acceleration, braking, turn signals, and windshield wipers, in order to notify other vehicles 104 and the individuals 102 operating such vehicles as to the traffic activities of the vehicles 104 in the travel region 202. Additionally, respective vehicles 104 may be configured to anonymize the operating telemetrics 208 shared with other vehicles 104 (e.g., sharing information on velocity and acceleration, but removing any personally identifying information of the individuals 102 owning, operating, and/or occupying the vehicles 104).

As a fourth variation of this fourth aspect, respective vehicles 104 may share with other vehicles 104 in the travel region 202 operating telemetrics 208 that are indicative of travel region properties detected by the vehicles 104 within the travel region 202, such as the velocities of other vehicles 104 in the travel region 202; traffic congestion locations of traffic congestion in the travel region 202; road hazards arising within the travel region 202; and available parking locations in the travel region 202. Respective vehicles 104 may also be configured to, upon receiving from a second vehicle 104 in the travel region 202 at least one operating telemetric 208 that is indicative of at least one travel region property, present the travel region properties to the individual 102.

FIG. 8 presents an illustration of an exemplary scenario 800 featuring a sharing of operating telemetrics 208 that are indicative of travel region properties of the travel region 202. For example, as two vehicles 104 pass each other on a road, the first vehicle 104 may transmit to the second vehicle 104 a first operating telemetric 208 indicating a road hazard 802 (such as a traffic accident) occurring on the road behind the first vehicle 104 and ahead of the second vehicle 104, thus providing the individual with the opportunity to avoid the road hazard 802. Concurrently or consecutively, the second vehicle 104 may transmit to the first vehicle 104 a second operating telemetric 208 indicating a the presence of traffic congestion 804 occurring on the road behind the second vehicle 104 and ahead of the first vehicle 104, thus providing the individual with the opportunity to avoid the traffic congestion 804. In this manner, vehicles 104 may transmit 206 to each other shared operating telemetrics 208 providing information about the travel region 202. Many such configurations of the vehicles 104 and devices contained therein may facilitate the individuals 102 in the operation of the vehicles 104 in accordance with the techniques presented herein.

### E. COMPUTING ENVIRONMENT

FIG. 9 and the following discussion provide a brief, general description of a suitable computing environment to implement embodiments of one or more of the provisions set forth herein. The operating environment of FIG. 9 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 9 illustrates an example of a system 900 comprising a computing device 902 configured to implement one or more embodiments provided herein. In one configuration, computing device 902 includes at least one processing unit 906 and memory 908. Depending on the exact configuration and type of computing device, memory 908 may be volatile (such as RAM, for example), non-volatile (such as ROM, flash memory, etc., for example) or some combination of the two. This configuration is illustrated in FIG. 9 by dashed line 904.

In other embodiments, device 902 may include additional features and/or functionality. For example, device 902 may also include additional storage (e.g., removable and/or non-removable) including, but not limited to, magnetic storage, optical storage, and the like. Such additional storage is illustrated in FIG. 9 by storage 910. In one embodiment, computer readable instructions to implement one or more embodiments provided herein may be in storage 910. Storage 910 may also store other computer readable instructions to implement an operating system, an application program, and the like. Computer readable instructions may be loaded in memory 908 for execution by processing unit 906, for example.

The term “computer readable media” as used herein includes computer storage media. Computer storage media includes volatile and nonvolatile, removable and non-removable media implemented in any method or technology for storage of information such as computer readable instructions or other data. Memory 908 and storage 910 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 902. Any such computer storage media may be part of device 902.

Device 902 may also include communication connection(s) 916 that allows device 902 to communicate with other devices. Communication connection(s) 916 may include, but is not limited to, a modem, a Network Interface Card (NIC), an integrated network interface, a radio frequency transmitter/receiver, an infrared port, a USB connection, or other interfaces for connecting computing device 902 to other computing devices. Communication connection(s) 916 may include a wired connection or a wireless connection. Communication connection(s) 916 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 902 may include input device(s) 914 such as keyboard, mouse, pen, voice input device, touch input device, infrared cameras, video input devices, and/or any other input device. Output device(s) 912 such as one or more displays, speakers, printers, and/or any other output device may also be included in device 902. Input device(s) 914 and output device(s) 912 may be connected to device 902 via a wired connection, wireless connection, or any combination thereof. In one embodiment, an input device or an output device from another computing device may be used as input device(s) 914 or output device(s) 912 for computing device 902.

Components of computing device 902 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 902 may be interconnected by a network. For example, memory 908 may be comprised of multiple physical memory units located in different physical locations interconnected by a network.

Those skilled in the art will realize that storage devices utilized to store computer readable instructions may be distributed across a network. For example, a computing device 920 accessible via network 918 may store computer readable instructions to implement one or more embodiments provided herein. Computing device 902 may access computing device 920 and download a part or all of the computer readable instructions for execution. Alternatively, computing device 902 may download pieces of the computer readable instructions, as needed, or some instructions may be executed at computing device 902 and some at computing device 920.

### F. USAGE OF TERMS

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A system for enforcing a vehicle operation policy to a vehicle on a device having a processor, a memory, and a vehicle operation policy, the system comprising:
a vehicle telemetry component comprising instructions stored in the memory that, when executed on the processor, cause the device to, while the vehicle is currently traveling in a travel region, receive from at least one telemetry sensor of the vehicle a transmission encoding at least one operating telemetric of the vehicle;
a vehicle operation policy evaluating component comprising instructions stored in the memory that, when executed on the processor, cause the device to, upon receiving the at least one operating telemetric from the vehicle, compare the at least one operating telemetric to the vehicle operation policy to identify a policy result; and
a policy result applying component comprising instructions stored in the memory that, when executed on the processor, cause the device to apply the policy result to the vehicle.

2. A method of enforcing a vehicle operation policy to a vehicle, the method involving a device having a processor and comprising:
executing on the processor instructions configured to:
receive from a telemetry sensor of the vehicle a transmission encoding at least one operating telemetric of the vehicle while traveling in the travel region;
compare the at least one operating telemetric to the vehicle operation policy to identify a policy result; and
apply the policy result to the vehicle.

3. The method of claim 2, the at least one operating telemetric selected from an operating telemetric set comprising:
a vehicle occupancy;
a vehicle location;
a vehicle velocity;
a vehicle acceleration;
a vehicle braking measurement;
a vehicle emissions measurement;
a vehicle tire pressure of at least one tire of the vehicle;
a vehicle operating light setting;
a vehicle windshield wiper setting;
a vehicle climate control setting;
a vehicle temperature measurement;
a vehicle water measurement;
a vehicle ice measurement;
a vehicle identifier;
a vehicle type descriptor;
a vehicle operator identifier; and
a vehicle operator demographic descriptor.

4. The method of claim 2:
receiving the at least one operating telemetric comprising:
from at least two vehicles traveling in the travel region, receiving from the telemetry sensors of respective vehicles a transmission encoding at least one operating telemetric of the vehicle; and
aggregating the operating telemetrics of the at least two vehicles into at least one aggregated operating telemetric of the vehicles traveling in the travel region.

5. The method of claim 2:
receiving the at least one operating telemetric comprising:
at a first time, receiving from the telemetry sensors of respective vehicles a first transmission encoding at least one first operating telemetric of the vehicle; and
at a second time, receiving from the telemetry sensors of respective vehicles a second transmission encoding at least one second operating telemetric of the vehicle; and
comparing the at least one first operating telemetric and the at least one second operating telemetric to identify a historic operating telemetric of the vehicle.

6. The method of claim 2:
the vehicle operation policy comprising a toll applicable to vehicles in the travel region, the toll proportional to the operating telemetric; and
applying the policy result to the vehicle comprising: charging the toll to the vehicle in accordance with the vehicle operation policy and the operating telemetric.

7. The method of claim 2:
the vehicle operation policy comprising a vehicle emissions policy;
the at least one operating telemetric comprising a vehicle emissions metric detected by a vehicle emissions detector during operation of the vehicle in the travel region; and
identifying the policy result comprising: comparing at least one vehicle emissions metric included in the at least one operating telemetric to the vehicle emissions policy.

8. The method of claim 2:
the vehicle operation policy comprising an occupancy minimum of an occupancy-restricted area of the travel region;
the at least one operating telemetric comprising an occupancy of the vehicle; and
identifying the policy result comprising, upon detecting a presence of the vehicle in the occupancy-restricted area, comparing the occupancy of the vehicle with the occupancy minimum specified by the vehicle operation policy.

9. The method of claim 2:
the vehicle operation policy associated with a travel region usage of the travel region by the vehicles; and
identifying the policy result comprising:
performing a comparison of the travel region usage indicated by the operating telemetric of the vehicle with the travel region usage by other vehicles in the travel region; and
applying the policy result to the vehicle in accordance with the comparison.

10. The method of claim 9, the travel region usage selected from a travel region usage set comprising:
a vehicle count of the vehicles operating in the travel region in a time period;
a vehicle weight of the vehicles operating in the travel region in a time period;
a vehicle speed of the vehicles operating in the travel region in a time period; and
a vehicle emission set of the vehicles operating in the travel region in a time period.

11. A method of facilitating an individual in operating a vehicle in a travel region, the method involving a device having a processor and comprising:
executing on the processor instructions configured to, while the vehicle is currently traveling in a travel region:
receive from a telemetry sensor at least one operating telemetric of the vehicle;
transmit the at least one operating telemetric to a telemetric monitoring component positioned outside of the vehicle in the travel region; and
upon receiving from the telemetric monitoring component at least one policy result of a vehicle operation policy applied to the at least one operating telemetric, apply the at least one policy result to the vehicle.

12. The method of claim 11, the instructions further configured to, before transmitting the at least one operating telemetric to the telemetric monitoring component:
present an offer to the individual to transmit the at least one operating telemetric to the telemetric monitoring component, and
receive from the individual an acceptance of the offer.

13. The method of claim 12, the instructions further configured to, upon transmitting the at least one operating telemetric to the telemetric monitoring component, confer a benefit upon the individual.

14. The method of claim 11, the instructions further configured to, upon receiving from the telemetric monitoring component an operating suggestion for operating the vehicle, present the operating suggestion to the individual.

15. The method of claim 12, the instructions further configured to, upon detecting an operating change by the individual conforming with the operating suggestion, confer a benefit upon the individual.

16. The method of claim 11, the instructions further configured to transmit the operating telemetric to the telemetric monitoring component through a second vehicle operating in the travel region.

17. The method of claim 11, the instructions further configured to share the operating telemetric with at least one second vehicle operating in the travel region.

18. The method of claim 17, the instructions further configured to anonymize the operating telemetric shared with the at least one second vehicle.

19. The method of claim 17, the operating telemetric indicative of at least one travel region property detected by the vehicle within the travel region, the travel region property selected from a travel region property set comprising:
at least one velocity of at least one vehicle in the travel region;
at least one traffic congestion location of traffic congestion in the travel region;
at least one road hazard arising within the travel region; and
at least one available parking location in the travel region.

20. The method of claim 11, the instructions further configured to, upon receiving from a second vehicle in the travel region at least one operating telemetric indicative of at least one travel region property, present the at least one travel region property to the individual.
